(19) United States
(12) Patent Application Publication
(10) Pub. No.: US 2013/0135710 A1
(43) Pub. Date: May 30, 2013

(54) WAVELENGTH CONVERSION DEVICE AND LASER DEVICE

(71) Applicant: Sumitomo Electric Industries, Ltd., Osaka-shi (JP)

(72) Inventors: Shigehiro NAGANO, Yokohama-shi (JP); Manabu SHIOZAKI, Yokohama-shi (JP)

(73) Assignee: SUMITOMO ELECTRIC INDUSTRIES, LTD., Osaka-shi (JP)

(21) Appl. No.: 13/670,185

(22) Filed: Nov. 6, 2012

(30) Foreign Application Priority Data
Nov. 24, 2011 (JP) 2011-255936

(51) Int. Cl. G02F 1/35

(52) U.S. Cl. 359/326

(57) ABSTRACT

The present invention relates to a wavelength conversion device and others. The wavelength conversion device is provided with an input port, a beam homogenizer, a wavefront aberration compensating element, and a nonlinear conversion element of a nonlinear optical crystal. The beam homogenizer forms a flat-top light intensity distribution of an output laser beam at a position different from a beam waist position thereof. Thereafter, the wavefront aberration compensating element outputs the laser beam coming from the beam homogenizer, as a phase-aligned collimated beam to the wavelength conversion element.

### BACKGROUND OF THE INVENTION

1. Field of the Invention

The present invention relates to a wavelength conversion device to implement high-efficiency wavelength conversion of a high-power pulsed or CW laser beam, using a wavelength conversion element of a nonlinear optical crystal, and a laser device including the wavelength conversion device.

2. Related Background of the Invention

A spatial intensity distribution (light intensity distribution) of a single-mode laser beam is a Gaussian distribution. When this laser beam is injected into a nonlinear optical crystal element for wavelength conversion as it is, wavelength conversion efficiency becomes high in a high-intensity distribution region and low in a low-intensity distribution region in the spatial intensity distribution. In the case of a high-power laser beam, a peak value thereof is limited by a damage threshold of the crystal or an antireflection coat thereon due to the laser beam. It leads to restrictions on increase in power of the laser beam and also to restrictions on a distribution region advantageous to conversion (a high-power region in the light intensity distribution of the laser beam) in the laser beam power. It results in also limiting the conversion efficiency. A solution to it is to make the spatial intensity distribution of the laser beam into the wavelength conversion device closer to a flat top shape.

In general, the spatial intensity distribution of the Gaussian distribution is converted into a spatial intensity distribution of the flat top shape, using a beam homogenizer such as a diffraction grating element (DOE: Diffractive Optical Element), g2T (trademark of Lissotschenko Mikrooptik GmbH), or an aspherical lens type. U.S. Pat. No. 7,499,207 (Patent Document 1) discloses a compensator and remapper to correct a spatial intensity distribution of an input laser beam into an ideal Gaussian distribution shape. Specifically, a compensator element as compensator remaps an input laser beam into an aligned laser beam consisting of parallel ray components with an even distribution and redirects the aligned laser beam. A remapper element as remapper remaps the aligned laser beam into a shaped laser beam with a round Gaussian distribution shape optimum to remap an even distribution into a spatial intensity distribution of a flat top shape. In Patent Document 1, while the beam homogenizer is made to function accurately, the laser beam with the spatial intensity distribution of the flat top shape is injected into the wavelength conversion device, thereby implementing wavelength conversion.

FIG. 1 is a drawing showing an example of a configuration of a conventional laser device 30. In FIG. 1, the conventional laser device 30 is provided with a light source device 1, a wavelength conversion device 20, and a single-mode optical fiber 2. The light source device 1 outputs a single-mode laser beam. The laser beam from the light source device 1 is guided through the optical fiber 2 to ensure single-mode propagation, to the wavelength conversion device 20. The wavelength conversion device 20 is provided with a collimator 3 having an input port 3′, a beam expander 4, a beam homogenizer 51 of a type to generate a side lobe (sidelobe-generating type hereinafter), and a wavelength conversion element 7, which are arranged in order along a traveling direction of the input laser beam. The wavelength conversion element 7 is provided with an input surface 11 at a position where the laser beam arrives, and an output surface 12 at a position where the laser beam is output.

The wavelength conversion device 20 receives the laser beam (in a single mode) output from the optical fiber 2, through the input port 3′ and the collimator 3 collimates the laser beam (into a parallel beam). The beam expander 4 expands the laser beam (collimated beam) output from the collimator 3, whereby the beam diameter of the laser beam is increased to a predetermined beam diameter. When the expanded laser beam is injected into the beam homogenizer 51, the spatial intensity distribution thereof is converted from the Gaussian distribution shape into the flat top shape (shape in which a peak part has a constant spatial intensity distribution). The wavelength conversion element 7 is located at a beam waist position of the laser beam condensed by the beam homogenizer 51. The reason why the wavelength conversion element 7 is located at the beam waist position is that the light intensity of the laser beam through the beam homogenizer 51 becomes maximum there, the spatial distribution of the flat top shape becomes the flattest at the beam waist position when compared to those in the other regions, and the laser beam becomes collimated without wavefront aberration (the spatial phase distribution of which is flat).

After the beam homogenizer 51 converts the shape of the spatial intensity distribution into the flat top shape, the laser beam is injected into the wavelength conversion element 7, in which the input laser beam is subjected to wavelength conversion while maintaining the spatial intensity distribution of the flat top shape; thereafter, the resultant laser beam is output from the wavelength conversion device 20.

The conversion efficiency of wavelength conversion increases with the square of a nonlinear optical coefficient of the wavelength conversion element 7 of the nonlinear optical crystal. The nonlinear optical coefficients vary depending upon polarization directions of incident light and, for example, in the QPM (quasi-phase matching) method, the highest nonlinear optical coefficient d₃₃ can be utilized for incident light with polarization parallel to the c-axis with respect to the crystal optic axis. Namely, preferred conditions for high-efficiency wavelength conversion are that the phase surface (wavefront) of the incident light is an equi-phase surface (flat) and that the phase surface is maintained across the entire length of the crystal optic axis. In that sense, the problem is just adjustment of installation orientation of the crystal optic axis as long as the wavelength conversion element 7 is installed at the beam waist position where the phase surface is flat.

FIGS. 2A to 2F show spatial intensity distributions and a spatial phase distribution of a laser beam in an experimental system to which the beam homogenizer 51 of the sidelobe-generating type (with sub-peak components appearing around a main peak in a light intensity distribution) is applied. Specifically, FIG. 2A is a drawing showing a configuration of the experimental system to which the beam homogenizer 51 of the sidelobe-generating type is applied. FIGS. 2B to 2F show the spatial intensity distributions (light intensity distributions) and spatial phase distribution of the beam in respective portions in the experimental system shown in FIG. 2A. For example, FIG. 2B shows an example of the spatial intensity distribution in a region A₁ shown in FIG. 2A, FIG. 2C an example of the spatial phase distribution in the region A₁ shown in FIG. 2A, FIG. 2D an example of the spatial intensity distribution in the region A₁ shown in FIG. 2A (which is the same as the figure shown in the bottom part in FIG. 2B), FIG. 2E an example of the spatial phase distribution in a region B₁ shown in FIG. 2A, and FIG. 2F an example of the spatial phase distribution in a region C₁ shown in FIG. 2A. FIGS. 2B to 2F are the measurement results in a state in which the wavelength conversion element 7 is not located.

A beam behavior will be described with the beam homogenizer 51 consisting of a DOE and a condensing lens, based on FIGS. 2A to 2F. The beam homogenizer 51 consisting of the DOE and condensing lens generally has a long (deep) depth of focus and is able to output the laser beam so as to optimize the spatial intensity distribution and beam cross-sectional shape of the laser beam at the beam waist position (i.e., so that the spatial intensity distribution is the flat top shape and the beam cross section is a rectangular shape). In that case, the beam cross section of the laser beam is a rectangular shape, as shown in FIG. 2B, in the region A₁ indicative of the beam waist position in FIG. 2A. The wavelength conversion is implemented by locating the wavelength conversion element 7 so as to include the beam waist position as described below. The light intensities shown in each drawing are normalized with respect to the peak value of the region A₁ as 1. The spatial intensity distribution of the laser beam in this region A₁ has a considerably steep shape of a rising of the rectangular part which defines the beam cross section as shown in FIG. 2B. However, there appears unintended sub-peaks of side lobes around the rectangular part. In the spatial phase distribution indicative of wavefront aberration in the region A₁, shown in FIG. 2C, the phase is also ideal. Concerning the spatial intensity distributions in the region A₁, region B₁, and region C₁ shown in FIGS. 2D to 2F, respectively, the region A₁ (FIG. 2D) and the region B₁ (FIG. 2E) show a slight change in light intensity in the central region but the beam profiles there are maintained in much the same shape. There are also side lobes in the region B₁. In the region C₁ (FIG. 2F), the side lobes cause a significant effect to lower the peak intensity and break the spatial intensity distribution. The region C₁ is desirably not to be included in the region of the wavelength conversion element, and if a reason for it is the existence of the side lobes, it is apparent that the absence thereof is preferred.

FIGS. 3A to 3C are drawings for explaining a spatial intensity distribution and spatial phase distribution of a laser beam in an experimental system to which a beam homogenizer 52 of a type to generate no side lobe (sidelobe-free type hereinafter) is applied. Specifically, FIG. 3A shows a configuration of the experimental system to which the beam homogenizer 52 of the sidelobe-free type is applied, FIG. 3B the spatial intensity distribution (light intensity distribution) of the beam in a region a of the experimental system shown in FIG. 3A, and FIG. 3C a drawing showing the spatial phase distribution of the beam in the region a of the experimental system shown in FIG. 3A. Examples of the beam homogenizer 52 of the sidelobe-free type include DOE, g2T, an aspherical lens, etc. of a type with a condensing function (having no condensing lens). When the beam homogenizer of this type is applied, a region where the spatial intensity distribution is the flat top shape, is not located at the beam waist position, but is located at a position of the region a or region β before or after the beam waist position, as shown in FIG. 3A. Namely, FIG. 3B and FIG. 3C show an example of the spatial light intensity distribution and spatial phase distribution on the assumption that there is a region where the spatial intensity distribution in the region α is the flat top shape. It is seen that the region α is good in both rectangularity of the beam cross section and flatness in the spatial intensity distribution of the laser beam having passed through the beam homogenizer 52, but the spatial phase distribution is not aligned, with occurrence of wavefront aberration.

### SUMMARY OF THE INVENTION

The inventors investigated the conventional laser device in detail and found the problem as described below. Namely, according to the inventors' investigation, it was found that in the shape conversion of spatial distribution in the beam homogenizer 52, where the beam cross section of the laser beam to be output was converted from a round shape to a rectangular shape, it was important to pay attention to the rectangularity of the beam cross section and other necessary properties. Specifically, it was also found that for adjustment of such rectangularity and other necessary properties, the wavelength conversion element 7 became needed to be installed at a predetermined position other than the region where the beam waist was formed, and in that case, it resulted in causing a change in the spatial phase distribution of the laser beam. In the present specification, the rectangularity is defined by (the sum of lengths of flat portions in respective sides of a rectangle (lengths excluding round portions at corners of rectangle part))/(the sum of lengths of the respective sides of the rectangle). Furthermore, the rectangularity is calculated from a rectangle shape of a beam cross section defined by the light intensity of 50% of the intensity peak in the spatial intensity distribution of the laser beam. For this reason, in the conventional laser device, the wavelength conversion element 7 of the nonlinear optical crystal comes to receive the laser beam with the flat-top spatial intensity distribution in a state in which the phase is not aligned in the beam cross section of the laser beam. In this case, the wavelength conversion element 7 of the nonlinear optical crystal must demonstrate different conversion efficiencies between the central region and the peripheral region in the spatial phase distribution of the laser beam. Since the spatial phase distribution has a slope from the central region to the peripheral region as described above, it was expected that the conversion efficiency was reduced by that degree.

Furthermore, a region where the flat top shape of the spatial intensity distribution is maintained (which will be referred to hereinafter as flat top region) becomes longer in comparison to a length of the depth of focus at the beam waist position of the laser beam output from the beam homogenizer 52 (provided that the depth of focus herein is a length of a region where an area determined by a spot size is within twice that at the beam waist position). As a consequence, the thickness of the wavelength conversion element 7 of the nonlinear optical crystal can be made longer, but the laser beam is a state in which it cannot be regarded as a parallel beam, in the wavelength conversion element 7 located in the flat top region. In that case, the conversion efficiency drops for the light in the region where the laser beam cannot be regarded as a parallel beam, and for light components away from the parallel beam, with the result that the thickness of the wavelength conversion element 7 cannot be fully utilized for the conversion efficiency.

In the case of the experimental system to which the beam homogenizer 52 of the sidelobe-free type is applied (FIG. 3A), there is no side lobe in the spatial intensity distribution of the output laser beam, as shown in FIG. 3B, and the wavelength conversion efficiency is improved by that degree. On the other hand, it has such disadvantage that the flat top depth is smaller than in the case of the beam homogenizer 51 and the beam flat region is located at the position away from the beam waist position, where the wavefront aberration is large. Therefore, it is expected that it is difficult to achieve a satisfactory wavelength conversion efficiency, without any measures. In the present specification, the flat top depth means a beam length of a laser beam in which a PV value of the light intensity distribution is held. The PV value of the light intensity distribution means a value of not more than 10% for a ratio defined by (a difference between a maximum and a minimum of light intensities in a flat portion)/(an average of light intensities in the flat portion). Examples of the beam homogenizer of the sidelobe-free type include g2T and the aspherical lens type and these are generally inexpensive in comparison to DOE.

The present invention has been accomplished in order to solve the problem as described above and it is an object of the present invention to provide a wavelength conversion device configured to convert a single-mode laser beam into a laser beam with a flat-top spatial intensity distribution (light intensity distribution) and then collimate the laser beam so as to reduce influence of the change of the spatial phase distribution of the laser beam, thereby achieving efficient wavelength conversion, and a laser device using the wavelength conversion device.

In order to achieve the above object, a wavelength conversion device according to the present invention, as a first aspect, comprises an input port, a beam homogenizer, a wavelength conversion element of a nonlinear optical crystal, and a wavefront aberration compensating element. In this first aspect, the input port receives a single-mode laser beam. The beam homogenizer receives the laser beam from the input port and outputs the laser beam to form a flat-top light intensity distribution at a predetermined position. On that occasion, the beam homogenizer forms a flat-top spatial intensity distribution of the laser beam having passed through the beam homogenizer, at a position different from a beam waist position of the laser beam. The wavelength conversion element includes the nonlinear optical crystal, receives the laser beam from the beam homogenizer, and outputs the laser beam with a flat-top light intensity distribution, while converting a wavelength thereof into one different from a wavelength of the input laser beam. The wavefront aberration compensating element is located on an optical path between the beam homogenizer and the wavelength conversion element. This wavefront aberration compensating element changes the laser beam coming from the beam homogenizer, into a phase-aligned collimated beam and outputs the collimated beam to the wavelength conversion element. In the present embodiment, an inclination of the wavefront of the laser beam (aberration) is defined as a spatial phase distribution.

As a second aspect applicable to the above first aspect, a cross section of the laser beam received by the input port is preferably round. The beam homogenizer is preferably one capable of changing the beam cross section of the input laser beam from a round shape into a rectangular shape. Furthermore, the wavefront aberration compensating element is preferably installed at a position where rectangularity of the cross section of the laser beam output from the beam homogenizer is not less than 60%.

As a third aspect applicable to at least any one of the above first and second aspects, the wavelength conversion device may further comprise a beam expander disposed between the input port and the beam homogenizer. The installation of the beam expander enables change in the beam diameter of the laser beam. In this case, it becomes feasible to control the rectangular size of the cross section of the laser beam output from the wavefront aberration compensating element, by the beam expander. When the beam homogenizer selected is one with a predetermined beam diameter suitable for an application, the beam expander can change the beam diameter of the laser beam so that the beam diameter of the laser beam received by the beam homogenizer can agree with the beam diameter that the beam homogenizer can tolerate. As a result, the beam homogenizer can output the laser beam with the flat-top light intensity distribution.

Furthermore, as a fourth aspect of the present invention, the wavelength conversion device according to at least any one of the first to third aspects is applicable to a laser device. The laser device according to this fourth aspect comprises a light source device, and the wavelength conversion device having the structure as described above. The light source device outputs a single-mode laser beam. This configuration allows the laser device of the fourth aspect to achieve high-efficiency wavelength conversion. As a fifth aspect applicable to the fourth aspect, the laser device preferably further comprises an optical fiber disposed between the light source device and the wavelength conversion device. This optical fiber has one end connected to an output port of the laser device and the other end connected to the input port of the wavelength conversion device, and allows the laser beam from the light source device to propagate in a single mode. For this reason, it is easy to maintain a propagation mode of the laser beam received by the input port of the wavelength conversion device, in the single mode. In the present embodiment, the beam homogenizer condenses the input collimated beam to form a beam waist. An end cap is provided at an exit end face of the optical fiber.

### BRIEF DESCRIPTION OF THE DRAWINGS

FIG. 1 is a drawing for explaining a configuration of a laser device of a conventional example.

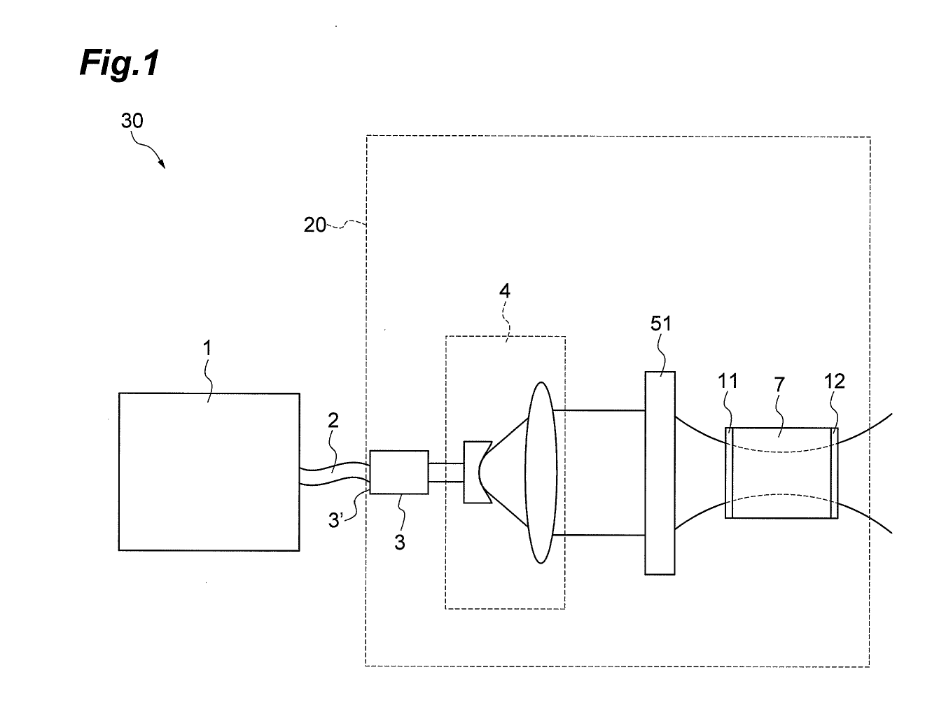

FIGS. 2A to 2F are drawings showing a configuration of an experimental system to which a beam homogenizer of a sidelobe-generating type is applied, and spatial intensity distributions (light intensity distributions) and a spatial phase distribution of a beam in respective portions of the experimental system;

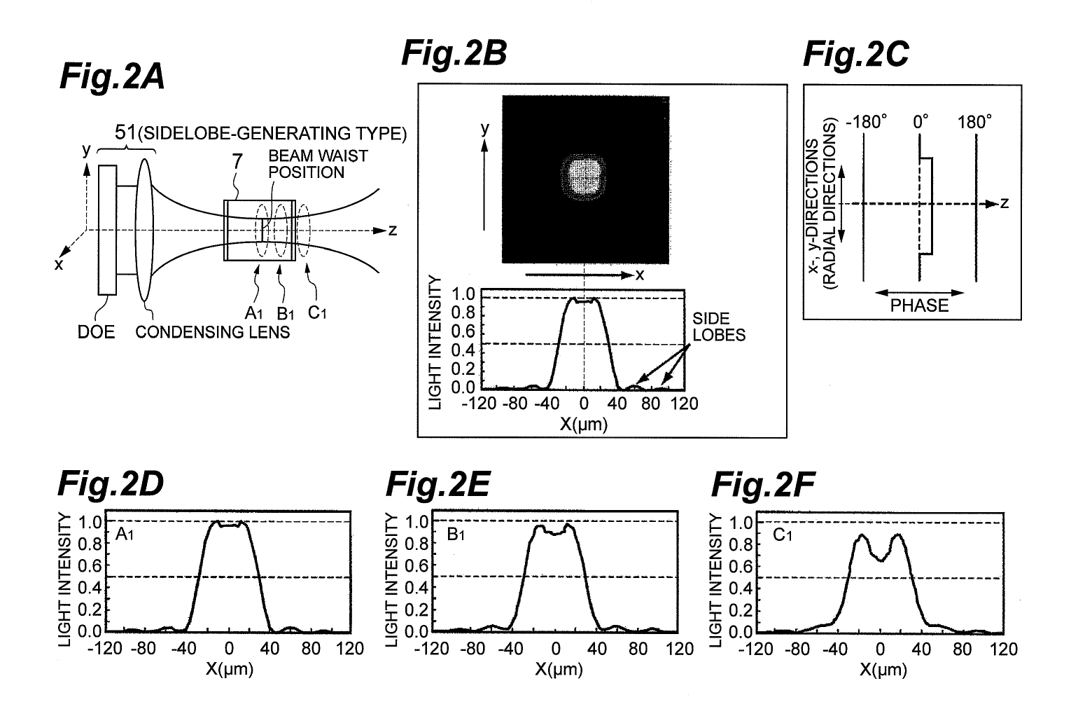

FIGS. 3A to 3C are drawings showing a configuration of an experimental system to which a beam homogenizer of a sidelobe-free type is applied, and a spatial intensity distribution (light intensity distribution) and a spatial phase distribution of a beam in respective portions of the experimental system;

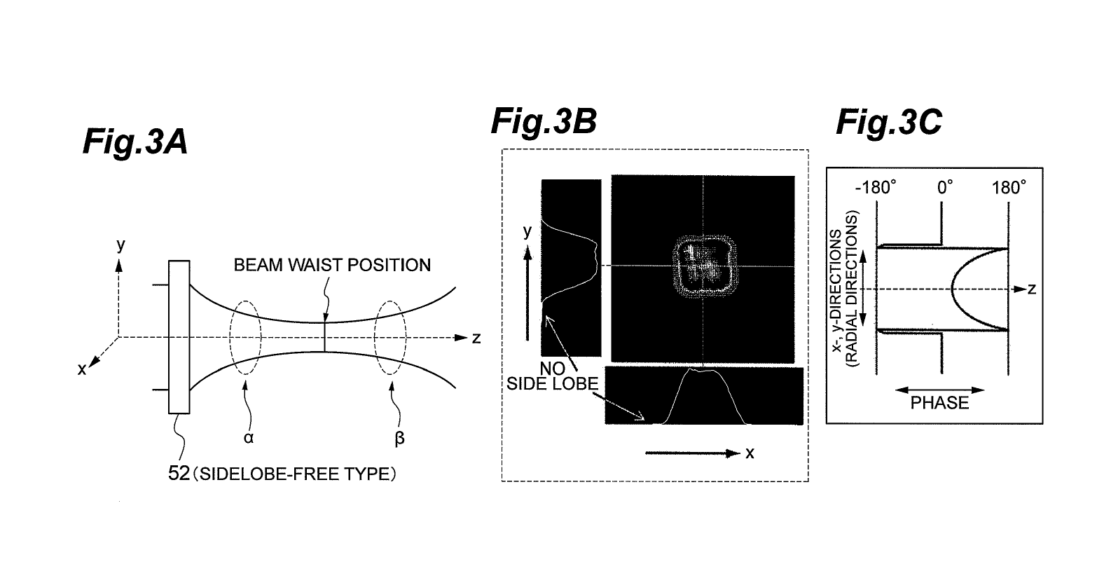

FIG. 4 is a drawing for explaining a configuration of a laser device according to an embodiment of the present invention;

FIGS. 5A and 5B are drawings for explaining a configuration of an experimental system to which a beam homogenizer of a sidelobe-free type is applied, and a relationship between light intensity distributions of a laser beam and forming positions thereof after the beam homogenizer 52;

FIGS. 6A to 6D are drawings for explaining a configuration of an experimental system to which a beam homogenizer of a sidelobe-free type is applied and in which a wavefront aberration compensating element and a wavelength conversion element are further installed after the beam homogenizer, and a relationship between light intensity distributions of a laser beam and forming positions thereof in respective portions of the experimental system;

FIGS. 7A to 7D are drawings for explaining a configuration of an experimental system in which the wavefront aberration compensating element and wavelength conversion element are installed at positions different from those in the experimental system shown in FIG. 6A, as a comparative example to the experimental system of FIG. 6A, and a relationship between light intensity distributions of a laser beam and forming positions thereof in respective portions of the experimental system;

FIGS. 8A to 8D are drawings for explaining a relationship between beam diameters of laser beams into the beam homogenizer and rectangular sizes of the laser beams into the wavelength conversion element;

FIGS. 9A to 9C are drawings showing changes of light intensity distributions of a laser beam in regions A₂ to D₂ shown in FIG. 4;

FIGS. 10A to 10D are drawings for explaining phase compensation in the wavefront aberration compensating element;

FIGS. 11A to 11C are drawings showing spatial phase distributions of a laser beam in the regions A₂ to D₂ shown in FIG. 4; and

FIG. 12 is a drawing showing an example of the configuration of the beam homogenizer shown in FIG. 4.

### DESCRIPTION OF THE PREFERRED EMBODIMENTS

Embodiments of the present invention will be described below in detail with reference to the accompanying drawings. In the description of the drawings the same elements will be denoted by the same reference signs, without redundant description.

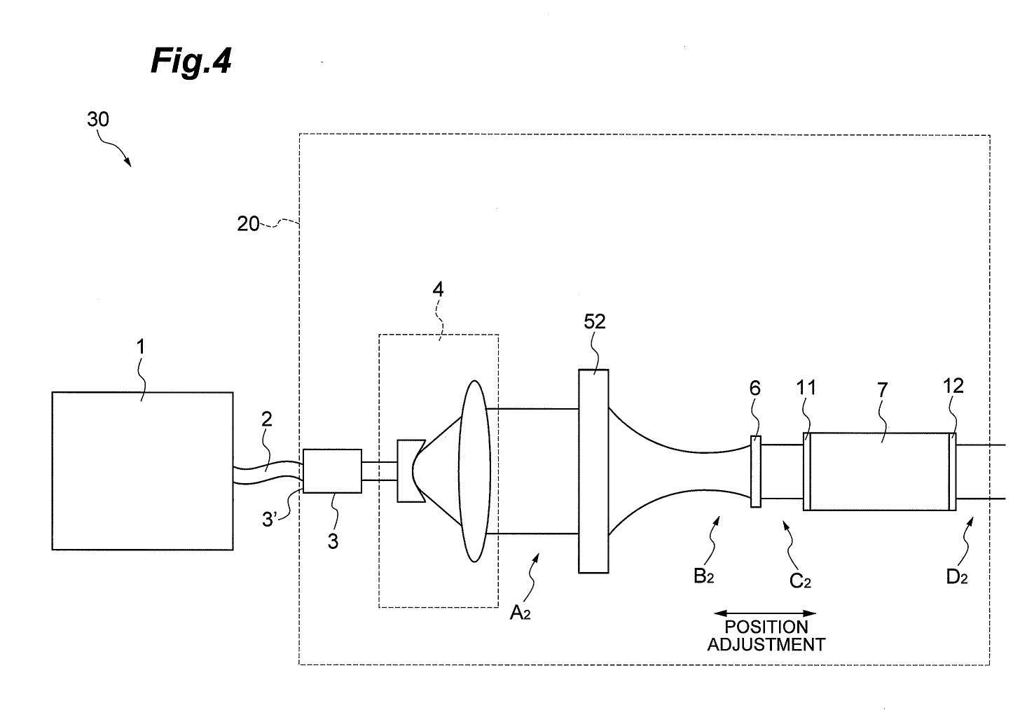

FIG. 4 is a drawing for explaining a configuration of a laser device according to an embodiment of the present invention, and the laser device is provided with a light source device 1, a wavelength conversion device 20, and a single-mode optical fiber 2 for guiding a laser beam output from the light source device 1, to the wavelength conversion device 20.

The light source device 1 applicable herein is a YAG laser, a DPSS (Diode Pumping Solid State) laser, a fiber laser, or the like. It can be any optical device that outputs a single-mode (spatial output power of a Gaussian distribution) laser beam. The output light from the light source device 1 is guided through the single-mode optical fiber 2 to the wavelength conversion device 20. The optical fiber 2 may be included in the light source device 1, or may be excluded if the beam light has high beam quality. The laser beam having propagated in a single mode in the optical fiber 2 is injected through the input port 3′ into the wavelength conversion device 20. A wavelength conversion element 7 as a nonlinear optical element is mounted inside the wavelength conversion device 20 and the wavelength conversion element 7 converts the wavelength of the laser beam into a wavelength different from that of the laser beam from the light source device 1 and outputs the laser beam of the converted wavelength from the wavelength conversion device 20.

The wavelength conversion device 20 is provided with a collimator 3 having an input port 3′, a beam expander 4, a beam homogenizer 52 of a sidelobe-free type, a wavefront aberration compensating element 6, and a wavelength conversion element 7 having an input surface 11 and an output surface 12, which are arranged in order along a propagation direction of the single-mode laser beam injected through the input port 3′. The collimator lens 3 collimates the single-mode laser beam injected through the input port 3′ (into a parallel beam) and thereafter the laser beam is guided into the beam expander 4. The beam expander 4 can increase the beam diameter of the laser beam at a predetermined magnification ratio and expands the input laser beam so as to have a specific beam diameter optimum to the beam homogenizer 52 located as a subsequent stage. As a matter of course, the beam expander 4 may be omitted if there is no need for expansion of the laser beam received by the beam homogenizer 52. Lenses of the beam expander 4 shown in FIG. 4 are just an example, and it is noted that, depending upon situations, the entrance-side lens surface may be a concave surface, the exit-side lens surface may be a flat surface, and the biconvex lens after the beam expansion may be replaced with a planoconvex lens. When the beam homogenizer 52 receives the laser beam in the specific beam diameter from the beam expander 4, the beam homogenizer 52 outputs the laser beam to form a flat-top light intensity distribution at a predetermined position. The beam homogenizer 52 may be, as a typical example, an optical device with a function to convert a cross-sectional shape of the output beam into a rectangular shape like g2T. The laser beam output from the beam homogenizer 52 is guided into the wavelength conversion element 7.

Since the rectangularity of the laser beam output from the beam homogenizer 52 and the PV value of the light intensity distribution of the laser beam vary depending upon the distance from the beam homogenizer 52, the installation position of the wavelength conversion element 7 is preferably set to an optimum position, after confirming an output state of the laser beam. The wavefront aberration compensating element 6 is installed on the optical path between the wavelength conversion element 7 and the beam homogenizer 52 and, as described below, this wavefront aberration compensating element 6 compensates for the phase of the laser beam from the beam homogenizer 52. The wavefront aberration compensating element 6 is installed at the aforementioned optimum position of the wavelength conversion element 7. FIG. 4 shows the wavefront aberration compensating element 6 installed at a position where the beam diameter becomes slightly larger on the wavelength conversion element 7 side from the beam waist position, but if the optimum position is located on the beam homogenizer side over the beam waist position, the wavefront aberration compensating element 6 will be located at the position; therefore, there are no particular restrictions on the installation side thereof.

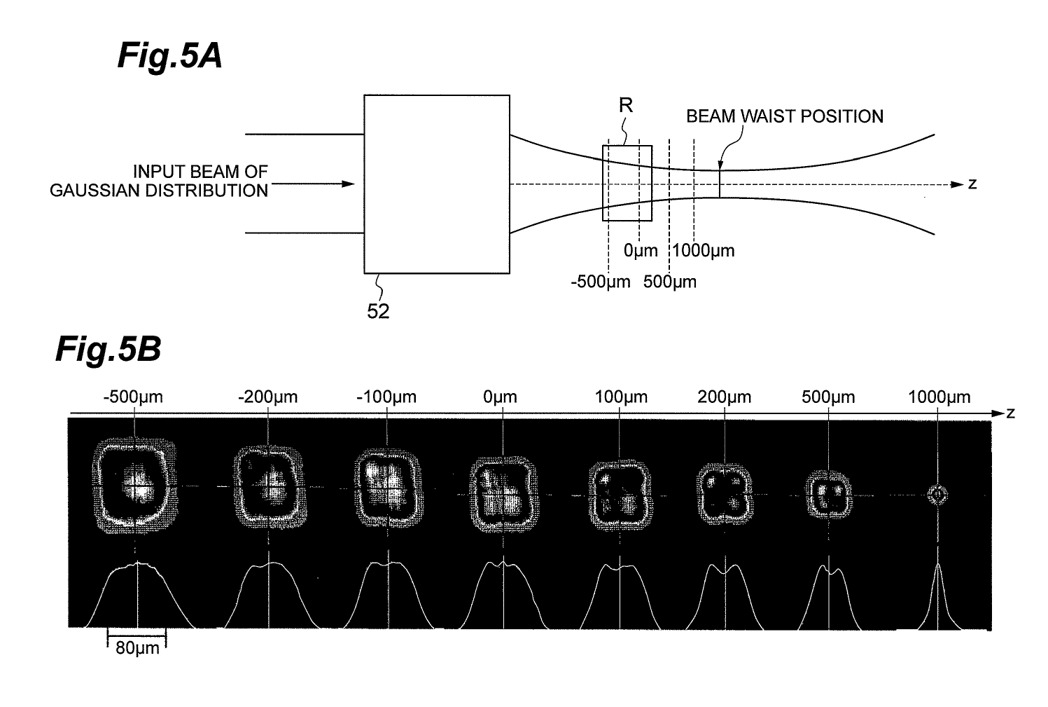

FIG. 5A is a drawing showing a configuration of an experimental system to which the beam homogenizer 52 of the sidelobe-free type is applied, and FIG. 5B a drawing for explaining a relationship between light intensity distributions of the laser beam and forming positions thereof after the beam homogenizer 52. The light intensity distributions show how light intensity varies depending upon positions on planes perpendicular to the optical axis direction of the laser beam (z-axis direction in the drawing). A region R in the drawing represents a region where a light intensity distribution with a rectangular flat top region (which will be referred to hereinafter as rectangular flat-top light intensity distribution) is obtained, which is only a region set according to an inventors' subjective viewpoint. The experimental system of FIG. 5A is an example in which g2T is applied as beam homogenizer 52. FIG. 5B shows the light intensity distributions of the laser beam in a region evaluated as the region where the rectangular flat-top light intensity distribution is formed (the region R). The position of “0 μm” in the z-axis direction is the optimum position where the rectangular size of the flat top region in the light intensity distribution (the length of the sides of the rectangle of the beam of rectangular cross section) is 80 μm, and it is the case where the beam diameter of the laser beam into the beam homogenizer 52 is also optimum, 1.8 mmφ. In this case, the PV value of the light intensity distribution is not more than 10%. The position of “0 μm” is a position away from the beam waist position in the example of FIG. 5A. FIG. 5B shows the light intensity distributions of the laser beam at positions with respective shifts of −100 μm, −200 μm, and −500 μm toward the beam homogenizer 52 and 100 μm, 200 μm, 500 μm, and 1000 μm toward the other side than the beam homogenizer 52 side, with respect to the position of “0 μm.” What is the optimum position can be determined according to various criteria, and in the present embodiment the optimum position is set based on the rectangularity. Another criterion may be provided if necessary. For example, the optimum position can be set according to an evaluation item such as the PV value, the rectangular size, or the flat top depth. In FIG. 5B peak values of light intensity are aligned, but an actual peak value is inversely proportional to a sectional area of the laser beam. If consideration is given only to the beam intensity of the laser beam, it is certain that the beam waist position is a position with a maximum peak; however, it is far from the viewpoint of the flat-top light intensity distribution and thus the beam waist position is an inappropriate position, different from the aim of the present invention. On the exit side with respect to the position of “0 μm,” the light intensity increases at the four corners of the flat top region (rectangular region) in the light intensity distribution, and the PV value tends to increase on the exit side with respect to the position of “0 μm.” Furthermore, the PV value tends to significantly increase beyond the boundary of the position of “200 μm.” Therefore, the positions on the exit side with respect to the position of “200 μm” are not preferred in terms of beam homogenization.

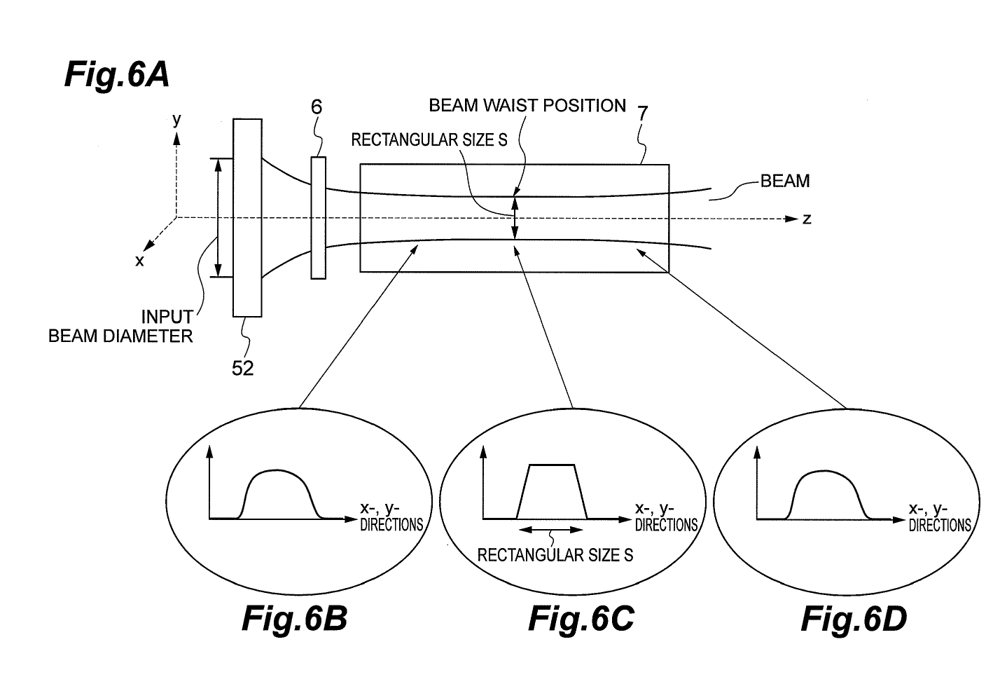

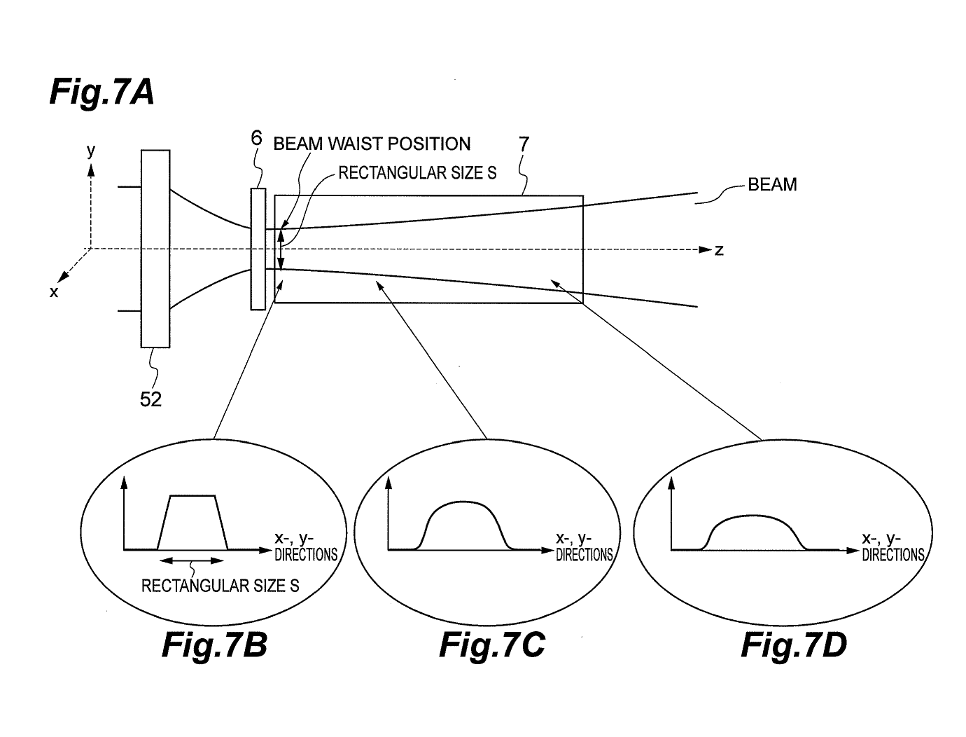

Next, FIG. 6A is a drawing showing a configuration of an experimental system to which the beam homogenizer 52 of the sidelobe-free type is applied and in which the wavefront aberration compensating element and wavelength conversion element are further installed after the beam homogenizer 52, and FIGS. 6B to 6D are drawings for explaining a relationship between light intensity distributions of the laser beam and forming positions thereof in respective portions of the experimental system (FIG. 6A). FIG. 7A is a drawing showing a configuration of an experimental system in which the wavefront aberration compensating element and wavelength conversion element are installed at positions different from those in the experimental system shown in FIG. 6A, as a comparative example to the experimental system of FIG. 6A, and FIGS. 7B to 7D are drawings for explaining a relationship between light intensity distributions of the laser beam and forming positions thereof in respective portions of the experimental system.

In FIG. 6A and FIG. 7A, the laser beam output from the beam homogenizer 52 is condensed as in the case where it passes through the condensing lens, and the wavefront aberration compensating element 6 located near the region where the flat-top light intensity distribution is formed, performs the compensation for the phase of the condensed laser beam. The flat-top light intensity distribution is held across a long distance by this configuration. In the region where the flat top depth including the beam waist position is deep (long), the laser beam can be basically regarded as a parallel beam. A point to be noted herein is that in the configuration to which the beam homogenizer 52 of the sidelobe-free type is applied, the beam waist position does not agree with the position where the flat-top light intensity distribution is formed, which requires an extra treatment. Then, in the experimental system of FIG. 6A, the wavefront aberration compensating element 6 is located at an optimum position before the position where the flat-top light intensity distribution is formed, on the assumption that the optimum position for wavelength conversion (the position where the flat-top light intensity distribution is formed) is located on the entrance side with respect to the beam waist position. This configuration enables wavelength conversion in a state with little wavefront aberration, for the laser beam having passed through the beam homogenizer 52 (cf. FIGS. 6B to 6D). In the experimental system of FIG. 7A, the wavefront aberration compensating element 6 is located at a position immediately before the position where the flat-top light intensity distribution is formed. The beam waist position is located near the laser beam entrance surface of the wavelength conversion element 7. For this reason, the light intensity distribution of the laser beam becomes in the best condition, near the entrance surface of the laser beam (cf. FIG. 7B). However, as the laser beam travels in the wavelength conversion element 7, the wavefront aberration increases to result in breaking the rectangular shape of the flat top region in the light intensity distribution (cf. FIG. 7C and FIG. 7D), bringing the light intensity distribution of the laser beam into an unfavorable state. As described above, it is seen by the comparison between the experimental system of FIG. 6A and the experimental system of FIG. 7A that the experimental system of FIG. 6A is more preferred.

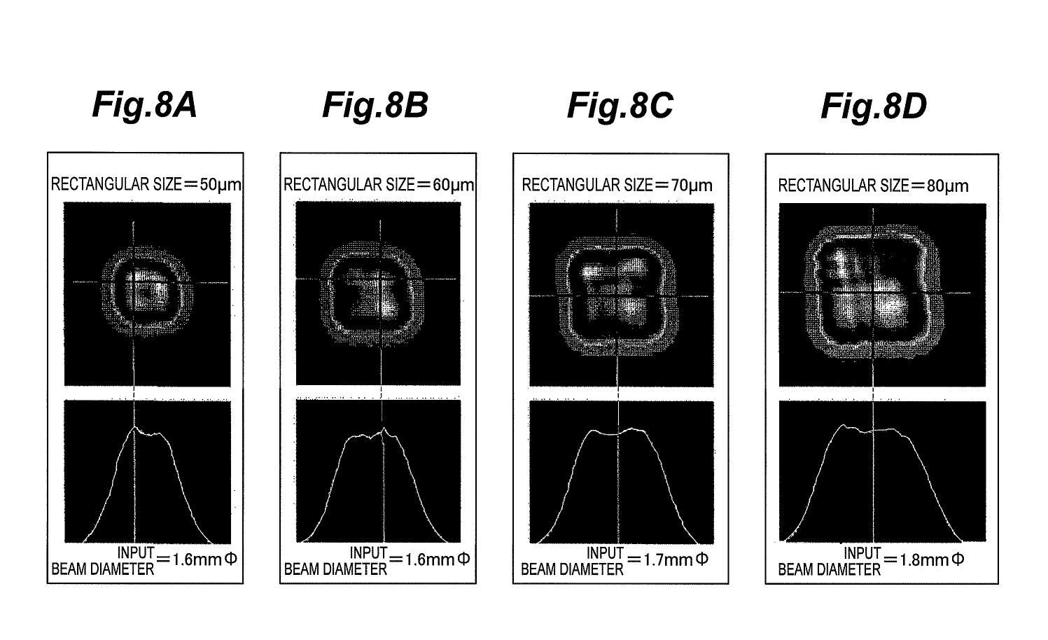

FIGS. 8A to 8D are drawings for explaining a relationship between beam diameters of laser beams received by the beam homogenizer and rectangular sizes of the laser beams received by the wavelength conversion element. The examples of FIGS. 8A to 8D show the light intensity distributions in cases where the rectangular size (cf. FIGS. 6A to 6D) is achieved at the position where the PV value of the light intensity distribution of the laser beam output from the beam homogenizer 52 becomes optimum (optimum position), and the input beam diameters (cf. FIGS. 6A to 6D) of the laser beams injected from the beam expander 4 into the beam homogenizer 52 in the cases achieving them. The optimum position is individually set based on the optimum PV value. The rectangular size is measured in a state without the wavelength conversion element 7. FIG. 8A shows the evaluation result with the rectangular size of 50 μm and the input beam diameter of 1.6 mm, FIG. 8B the evaluation result with the rectangular size of 60 μm and the input beam diameter of 1.6 mm, FIG. 8C the evaluation result with the rectangular size of 70 μm and the input beam diameter of 1.7 mm, and FIG. 8D the evaluation result with the rectangular size of 80 μm and the input beam diameter of 1.8 mm. The laser beam may be a round beam instead of the rectangular beam. Furthermore, it is also possible to adopt a method in which the PV value of the light intensity distribution is set principally in a good range and the input beam diameter is determined corresponding to the diameter size, instead of the rectangular size.

In the above evaluation results, the setting of the input beam diameter into the beam homogenizer 52 also contributes to the setting of the rectangular size, in addition to the optimum position of the wavefront aberration compensating element 6. The foregoing was described with focus on the relationship between rectangular size and incident beam diameter. In the case of the rectangular size of 80 μm, the flat top depth is shallow (short), in connection with the thickness of the wavelength conversion element. In terms of making the flat top depth deep (long), the rectangular size is considered to be preferably set in the range of about several hundred μm to several mm, though it depends upon the output of the laser beam source in practical wavelength conversion.

When the beam waist position is different from the position where the flat-top light intensity distribution is formed, the wavelength conversion device according to the present embodiment is effective to improvement in conversion efficiency. When the wavelength conversion element is installed at the position where the aforementioned rectangularity or PV value is optimum, there arises the problem on the phase of the laser beam, but the present embodiment solved the problem on the phase of the laser beam by provision of the wavefront aberration compensating element 6 to improve it. Although it depends upon the desired rectangular size, it is possible to design the wavefront aberration compensating element 6 optimum to the length of the nonlinear optical crystal depending upon the wavelength band available for wavelength conversion. Namely, it is feasible to control the degree of collimation into a parallel beam and to control the interaction length contributing to the wavelength conversion, and therefore it is feasible to achieve high-efficiency wavelength conversion. Furthermore, the beam homogenizer 52 in the present embodiment, different from the conventional beam homogenizer 51, generates no side lobe. For this reason, the present embodiment suppresses reduction in power density of the laser beam and thus produces a merit of implementing the wavelength conversion of larger output by that degree.

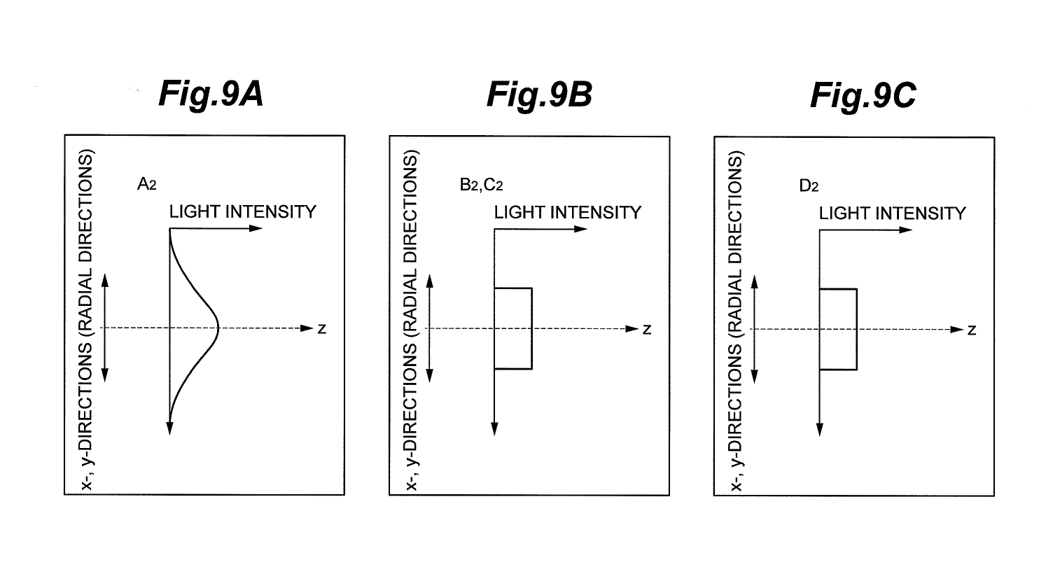

FIGS. 9A to 9C are drawings showing changes in the light intensity distributions of the laser beam in the regions A₂ to D₂ shown in FIG. 4. Namely, FIG. 9A shows the change in the light intensity distribution of the laser beam in the region A₂, FIG. 9B the change in the light intensity distribution of the laser beam in each of the regions B₂ and C₂, and FIG. 9C the change in the light intensity distribution of the laser beam in the region D₂.

The laser beam in the region A₂ in FIG. 4, which was output from the beam expander 4, is the single-mode beam and has the light intensity distribution showing a Gaussian distribution, as shown in FIG. 9A. The laser beam in each of the regions B₂ and C₂ in FIG. 4, which was output from the beam homogenizer 52, forms a flat-top light intensity distribution, as shown in FIG. 9B. In this case, since the peak region of the light intensity distribution becomes flat, the light intensity can be increased for the entire region where the light intensity is controlled to below the light intensity of the peak region. In addition, a ratio of the region (peak region) achieving high-efficiency conversion, to the light intensity distribution increases. The laser beam in the region D₂ in FIG. 4, which was output from the wavelength conversion element 7, maintains the flat-top light intensity distribution, as shown in FIG. 9C.

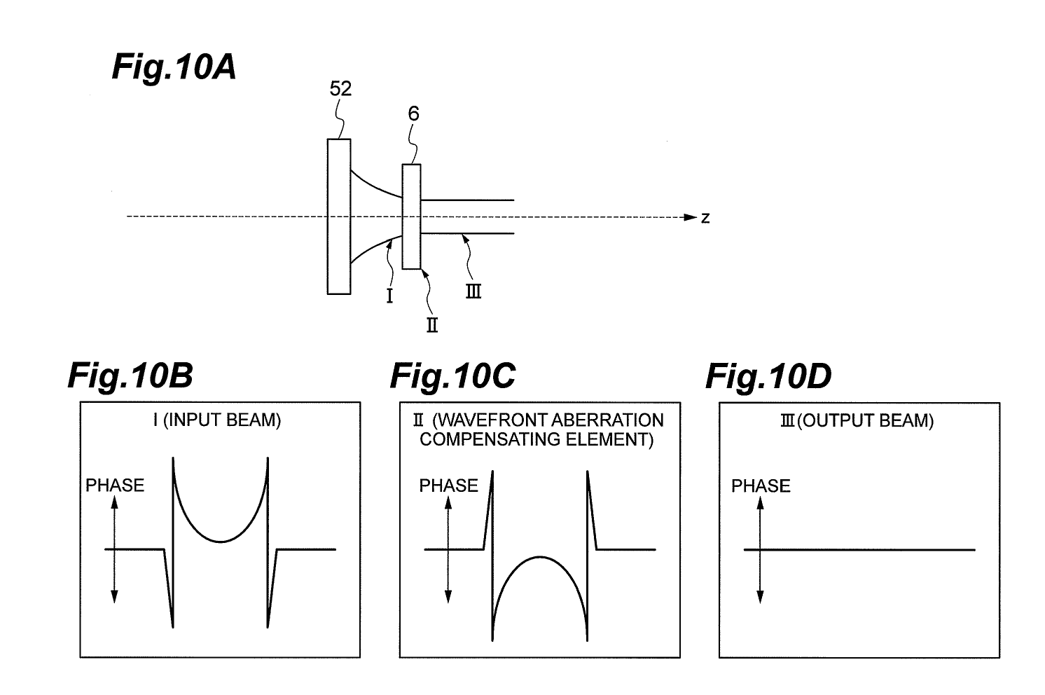

FIGS. 10A to 10D are drawings for explaining the phase compensation in the wavefront aberration compensating element. FIG. 10A is a drawing showing a configuration of an experimental system in which the beam homogenizer 52 of the sidelobe-free type and the wavefront aberration compensating element 6 are arranged, FIG. 10B shows spatial phases in a region I (input beam) in FIG. 10A, FIG. 10C shows a spatial phase distribution in a region II (wavefront aberration compensating element) in FIG. 10A, and FIG. 10D a spatial phase distribution in a region III (output beam) in FIG. 10A.

It is speculated that the spatial phase distribution occurs in directions perpendicular to the optical axis z in the beam cross section of the laser beam and the phase surface is distorted, as shown in FIG. 10B. In order to compensate for this distortion, the wavefront aberration compensating element 6 has a spatial phase distribution reverse to the spatial phase distribution of FIG. 10B, in the beam cross section of the laser beam, as shown in FIG. 10C. After having passed through the wavefront aberration compensating element 6, the laser beam is fixed in a phase-compensated state and is output as a parallel beam, as shown in FIGS. 10A and 10D. The spatial phase distribution appears discontinuous in each of FIGS. 10B and 10C, but it is continuous in fact because the vertical direction represents the phase with the upper limit and the lower limit of phase being +180° and −180°, respectively, and the indications are reversed at the positions of the limits.

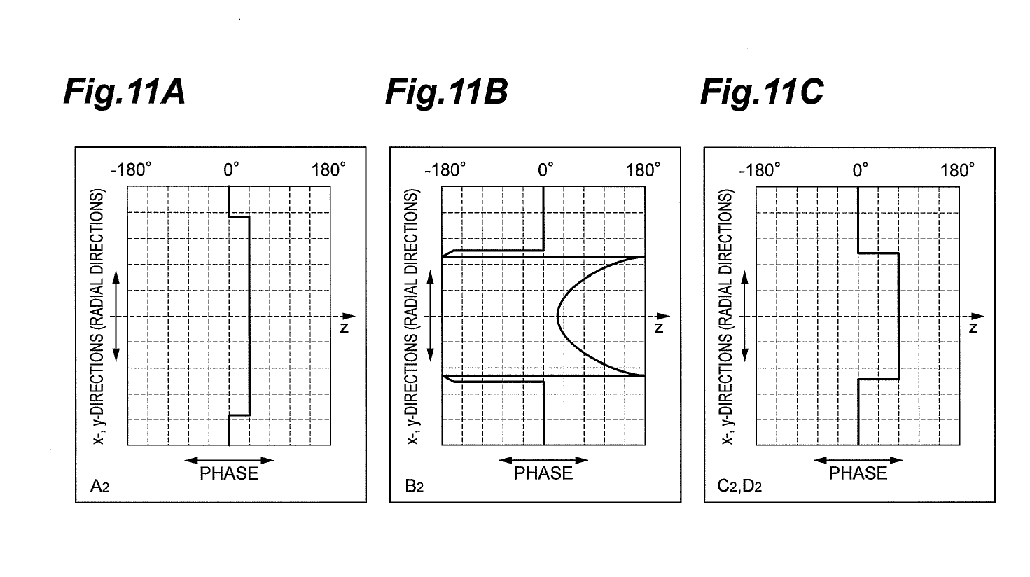

Furthermore, FIGS. 11A to 11C are drawings showing the spatial phase distributions of the laser beam in the regions A₂ to D₂ shown in FIG. 4.

The phase of the laser beam in the region A₂ in FIG. 4, which was output from the beam expander 4, is aligned as shown in FIG. 11A. Therefore, the phase surface of the laser beam in the region A₂ is in a distortion-free state. In the case of the laser beam in the region B₂ in FIG. 4, which was output from the beam homogenizer 52, there appears a spatial phase distribution in directions perpendicular to the optical axis z in the beam cross section of the laser beam, as shown in FIG. 11B. For this reason, it is speculated that the phase surface of the laser beam in the region B₂ is distorted when compared to the flat phase surface of FIG. 11A. The laser beam in each of the regions C₂ and D₂ in FIG. 4, which was output from the wavefront aberration compensating element 6, is compensated for this distortion and collimated. Thanks to this configuration, the phase of the laser beam is aligned in the beam cross section of the laser beam, as shown in FIG. 11C. Therefore, the phase surface of the laser beam in the region C₂ is in a distortion-free state. The beam diameter of the laser beam is increased after passage through the beam expander 4 and is thus large as shown in FIG. 11A. On the other hand, the beam diameter of the laser beam immediately before the phase compensation is small, as shown in FIG. 11B, because the beam is condensed by the beam homogenizer 52. The size of the beam is also varied by the installation position of the wavefront aberration compensating element and the size of the incident beam diameter into the beam homogenizer, as well as the beam homogenizer designed in the size of the desired rectangular flat top. The beam diameter of the laser beam after passage through the wavefront aberration compensating element 6 and the wavelength conversion element 7 is approximately equal to that in FIG. 11B, as shown in FIG. 11C.

As described above, the wavelength conversion device according to the present embodiment achieves the conversion of the spatial intensity distribution (light intensity distribution) of the laser beam into the flat top shape and the compensation for the spatial phase distribution as well, thus achieving improvement in wavelength conversion efficiency.

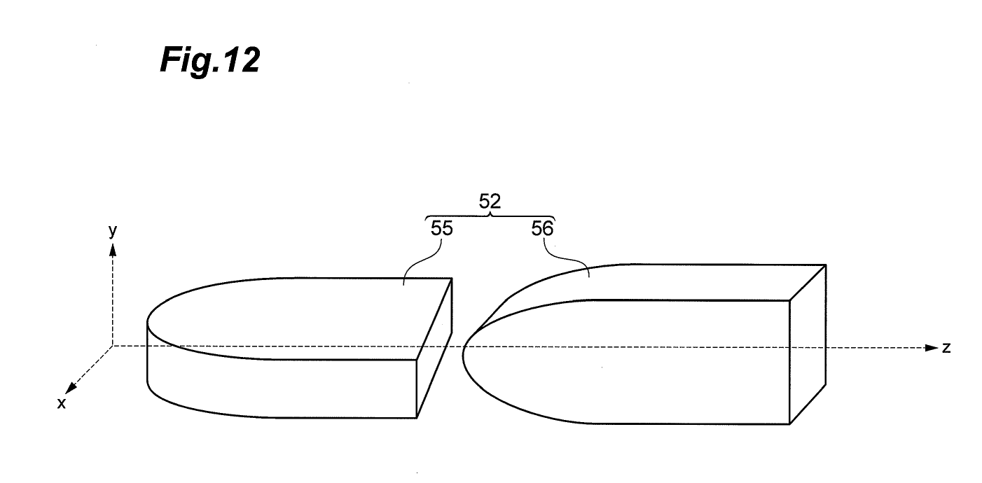

FIG. 12 is a drawing showing an example of the configuration of the beam homogenizer shown in FIG. 4. The beam homogenizer 52 can be implemented by a configuration wherein two aspherical lenses 55, 56 are arranged in directions perpendicular to the z-axis, as shown in FIG. 12, as well as by g2T or the aspherical lens. The aspherical lenses 55, 56 have respective surfaces curved both on the x-z plane and on the y-z plane, and output surfaces thereof are rectangular surfaces. By this configuration, the output beam becomes an output beam having a rectangular cross section. The output beam is beam-homogenized by the effect of the curved surfaces.

The present invention achieves the conversion of the light intensity distribution of the wavelength-converted laser beam into the flat top shape and the compensation for the spatial phase distribution as well, thereby enabling higher-efficiency wavelength conversion.

What is claimed is:

1. A wavelength conversion device comprising:
an input port for receiving a single-mode laser beam;
a beam homogenizer for receiving the laser beam from the input port and outputting the laser beam to form a flat-top light intensity distribution at a predetermined position, said beam homogenizer forming a flat-top spatial intensity distribution of the laser beam having passed through the beam homogenizer, at a position different from a beam waist position of the laser beam;
a wavelength conversion element of a nonlinear optical crystal for receiving the laser beam from the beam homogenizer and outputting the laser beam with a top-flat light intensity distribution, while converting a wavelength of the beam into a wavelength different from a wavelength of the input laser beam; and
a wavefront aberration compensating element located on an optical path between the beam homogenizer and the wavelength conversion element, said wavefront aberration compensating element changing the laser beam coming from the beam homogenizer, into a phase-aligned collimated beam and outputting the collimated beam to the wavelength conversion element.

2. The wavelength conversion device according to claim 1, wherein a cross section of the laser beam received by the input port is round,
wherein the beam homogenizer is one capable of changing a beam cross section of the input laser beam from a round shape into a rectangular shape, and
wherein the wavefront aberration compensating element is installed at a position where rectangularity of the beam cross section of the laser beam output from the beam homogenizer becomes not less than 60%.

3. The wavelength conversion device according to claim 1, further comprising:
a beam expander located between the input port and the beam homogenizer and being capable of changing a beam diameter of the laser beam.

4. A laser device comprising:
a light source device for outputting a single-mode laser beam; and
the wavelength conversion device as defined in claim 1, for receiving the laser beam from the light source device.

5. The laser device according to claim 4, further comprising:
an optical fiber disposed between the light source device and the wavelength conversion device, for guiding the laser beam from the light source device as a single-mode beam to the input port of the wavelength conversion device.
